(19) United States
(12) Patent Application Publication
(10) Pub. No.: US 2005/0180160 A1
(43) Pub. Date: Aug. 18, 2005

(54) Hemispherical illuminator for three dimensional inspection

(75) Inventor: Brett Kilgore Nelson, Scotts Valley, CA (US)

Correspondence Address: Brett K. Nelson, 100 Royal Oak Court, Scotts Valley, CA, 95066, US

(73) Assignee: Brett K. Nelson, Scotts Valley, CA (US)

(21) Appl. No.: 11/059,069

(22) Filed: Feb. 16, 2005

Related U.S. Application Data
(60) Provisional application No. 60/545,068, filed on Feb. 17, 2004.

(51) Int. Cl. F21V 9/00

(52) U.S. Cl. 362/555

(57) ABSTRACT

An illuminator for measurement of curved specular surfaces is provided comprising a hemispherical support structure containing single or multiple polygonal groups of directional light sources, whose beams converge at a point underneath the hemisphere containing the area to be inspected. The lights reflect from the curved surfaces vertically through an aperture in the top of the hemisphere to one or more cameras that are part of a machine vision system. In one form of the embodiment, two octagonal groups of LEDs (Light Emitting Diodes) mounted at different elevations on the hemisphere are used. The shapes and patterns of the reflected points of light serve as fiducials for measurement of the positions, radii, surface quality and relative heights of the curved surfaces.

REFERENCES CITED

REFERENCES CITED

| | | | |
|---|---|---|---|
| 4655592 | April, 1987 | Allemand | 356/237 |
| 4677473 | June, 1987 | Okamoto, et al. | 358/101 |
| 4729070 | March, 1988 | Chiu | 362/33 |
| 4729079 | March, 1988 | Maylotte | 362/350 |
| 4972093 | November, 1990 | Cochran, et al. | 250/559.08 |
| 4988202 | January, 1991 | Nayar, et al. | 356/394 |
| 5023916 | June, 1991 | Breu | 382/150 |
| 5039868 | August, 1991 | Kobayashi et al. | 250/559.08 |
| 5058178 | October, 1991 | Ray | 382/150 |
| 5064291 | November, 1991 | Reiser | 356/625 |
| 5072127 | December, 1991 | Cochran, et al. | 250/559.39 |
| 5051872 | September, 1991 | Anderson | 362/558 |
| 5143436 | September, 1992 | Baylor | 362/582 |
| 5166985 | November, 1992 | Takagi, et al. | 382/150 |
| 5245671 | September, 1993 | Kobayashi, et al. | 382/150 |
| 5302836 | April, 1994 | Siu | 250/559.34 |
| 5367439 | November, 1994 | Mayer | 362/551 |
| 5455870 | October, 1995 | Sepai, et al. | 382/147 |
| 5574801 | November, 1996 | Collet-Beillon | 382/150 |
| 5613753 | March, 1997 | Anderson | 362/560 |
| 5828449 | October, 1998 | King, et al. | 356/237.1 |
| 5926557 | July, 1999 | King, et al. | 382/149 |
| 5943125 | August, 1999 | King, et al. | 356/237.1 |
| 6064756 | May, 2000 | Beaty | 382/146 |
| 6118524 | September, 2000 | King, et al. | 356/237.1 |
| 6201892 | March, 2001 | Ludlow, et al. | 382/149 |
| 6236747 | May, 2001 | King, et al. | 382/149 |
| 6291816 | September, 2001 | Liu | 250/234 |
| 6454437 | September, 2002 | Kelly | 362/246 |
| 6542236 | April, 2003 | Kim | 356/394 |
| 6547409 | April, 2003 | Kiest, et al. | 362/33 |
| 6778282 | August, 2004 | Smets, et al. | 356/614 |

### FIELD OF THE INVENTION

This invention relates to the three dimensional measurement of specular curved surfaces as may be found on the electrical contacts of Ball Grid Array (BGA) and Chip Scale Package (CSP) semiconductor chips as well as bumped semiconductor wafers.

### BACKGROUND OF THE INVENTION

As the semiconductor industry has adapted the use of solder balls as electrical contacts for chip packages, the need has arisen to quickly and conveniently ascertain the integrity of these contacts in various stages of the manufacturing. The quickest and most non-invasive form of measuring contact integrity is visual. Computer assisted automatic inspection of BGA and CSP chips is especially useful after electrical testing of the contacts in order to make sure that abrasion of the testing probes against the solder balls has not dislodged a contact or caused surface damage that might affect the performance of the part. In a similar way, measuring the quality of metallic bumps deposited directly on semiconductor wafers during manufacturing is needed to monitor production processes and maximize yields.

There are many systems described for the purpose of inspection of solder balls on semiconductor chips. Much of this prior art relies on the use of ring-shaped illumination to directly illuminate the surface of the chip in a dark-field format such that a reflection of the ring is directed upward to the camera or cameras of a machine vision system. In these configurations, each solder ball presents a small circle of light or “doughnut” to a camera mounted directly above the chip. The measured radius of this “doughnut” by the machine vision system can be used to calculate the size of the individual ball, its XY position on the package and its relation to other balls. Cameras mounted at an angle off of the orthogonal axis see a distorted view of the ring illumination with the benefit of being able to use the measured positions and radii to calculate the relative heights of each ball and thus infer the coplanarity of the contact surface.

These ring illuminators mount a multitude of light emitting diodes (LEDs) in a circular fashion. The radius of the ring has been described to be as much as 15 cm in order to properly illuminate chip sizes up to 40 mm. U.S. Pat. No. 6,547,409 (incorporated herein by reference) describes 64 LEDs being used in a single ring. An essential requirement of ring illumination systems is that the total light coming from each LED in the ring must be identical so that there are no brightness variations around the circumference. U.S. Pat. No. 5,828,449 (incorporated herein by reference) describes the use of a diffuser to help even out the gaps of light between LEDs. As the machine vision system software measures the width of a reflected “doughnut” from inner to outer diameter at several different locations, variations in the doughnut brightness adversely affects the accuracy of the results.

In addition, U.S. Pat. Nos. 6,547,409 and 6,542,236 (incorporated herein by reference) describe the use of multiple rings of light that may be used in succession or together to highlight various elevations of the solder ball surface. It can be readily seen that the relative brightness of over one hundred LEDs must be maintained constant in such systems adding to the complexity and cost of the associated control electronics. It should also be noted that taking multiple camera exposures of the semiconductor package contacts using different illumination rings substantially increases the amount of time needed for inspection.

### BACKGROUND OF THE INVENTION—OBJECTS AND ADVANTAGES

The advantages of this present invention arise from the use of distinct points of light reflecting off of the curved surfaces rather than a plurality of points that merge and form a ring. One advantage is that since there are fewer LEDs used (typically 16 vs. 64+), the total parts cost of the illuminator and control electronics is lower. Another advantage is a significant labor savings in sorting and selecting LEDs of matching brightness.

In addition, it is comparatively easy to mathematically model and precisely measure the attributes of a single reflection point. When the ring light reflects from a sphere, the intensity of each pixel of the “doughnut” has components from several LED positions in the ring averaged together. How each LED contributes to an individual “doughnut” radius measurement is lost. In the present invention, each reflection is generated by a single LED position and the position of the reflection precisely indicates the orientation of that particular LED to that particular portion of the curved surface in the overall XY area illuminated. The reflection position can be quickly determined to subpixel accuracy by having the machine vision system calculate the centroid of the reflection.

The present invention allows more of the surface of the ball or bump to be measured in a shorter period of time. By controlling which lights are enabled, the vertices of diamond and square shaped patterns of light can be reflected off of the curved surfaces and captured in a single-frame by the machine vision camera. This allows two sets of ball diameter measurements to be made using one captured bitmap. In contrast, to do this with a dual ring system would require taking one exposure with one ring light and a separate exposure using the second ring light. These two bitmaps are then processed which requires at least twice the total capture time and measurement time of the present invention.

Finally, the invention's technique of using structured light to generate point reflections lends itself more easily to the use of folded optics. By bouncing the beams of light from the point sources off of mirrors before the beams illuminate the chip or wafer surface, the effective size of the hemisphere diameter can be tripled and a larger area illuminated. The functional effect of a 300 mm ring light can be duplicated in a space of 100 mm by using discrete point reflections and folded optics.

### SUMMARY OF THE INVENTION

The present invention features an illuminator for supplying precisely positioned point reflections on curved specular surfaces. Typically these curved surfaces are solder balls mounted on BGA/CSP chips or metallic bumps deposited on a semiconductor wafer. The illuminator comprises a hemispherical housing embedded with directional light sources aimed at the sphere's center. These light sources are arranged in horizontal groups at the vertices of regular polygons with each group located at a different vertical elevation on the housing. The housing defines an aperture situated along an axis perpendicular to the plane passing through the largest circle of the hemispherical housing, with the axis passing through the center of the largest circle. The beams of light from the directional light sources converge upon the center of the sphere where the part is placed; forming reflections on the part's curved surfaces, which can be inspected through the aperture. Controlling electronics turn on different groups of lights such that the reflected patterns can take the form of the original polygon shape or alternate shapes by the use of subsets of lights from each group.

The preferred embodiment of this invention uses two groups of 8 LEDs mounted at the vertices of regular octagons on the surface of the supporting hemisphere. The 16 LEDs are hand selected from a single production lot according to brightness in order to guarantee uniformity of illumination. The first group is located at an elevation of approximately 10 degrees from the largest circle of the hemisphere and the second group at 35 degrees. The LEDs project light beams with 20 to 30 degrees of divergence. The aperture at the top of the hemisphere is wide enough to allow unobstructed viewing of the illuminated surfaces for two cameras. The first camera is mounted directly over the illuminated surface along the center axis of the support housing. The second camera is mounted at an angle of 30 degrees off this center axis. Each group of 8 LEDs is divided into two subgroups of 4. One subgroup can be thought of as producing reflections located at the points of a compass: North, East, South, and West. The second subgroup produces interleaved reflections at NorthEast, SouthEast, SouthWest, and NorthWest. The first group of LEDs at 10-degree elevation produce the largest diameter octagonal reflection pattern or “octet.” The second group of LEDs at 35-degree elevation produce a smaller identical pattern located inside the first octet.

A second embodiment of this invention uses a single group of 8 LEDs mounted in an octagonal support housing that approximates the hemisphere. This is accomplished by using 8 mirrors along the lower periphery of the housing with an LED mounted above each mirror. The LED is mounted at an angle so that each beam traverses the entire width of the housing, hits the mirror on the opposite wall of the housing and then is reflected down to the part located at the bottom center of the housing. In this way, the light from each LED travels on average 1.5 times (1.5×) the structure width before reaching the part or wafer surface. This folded optics approach allows an effective ring illuminator diameter of three times (3×) the width of the octagonal support structure.

### BRIEF DESCRIPTION OF THE DRAWINGS

While the specification concludes with claims particularly pointing out and distinctly claiming the present invention, objects and advantages of the invention can be more readily ascertained from the following description of a preferred embodiment when used in conjunction with the accompanying drawings in which:

FIG. 1 is a sectional side view of the illuminator in accordance with the present invention, taken along the lines 1-1 of FIG. 2; and

FIG. 2 is a partially cut-away vertical view of the illuminator of FIG. 1.

FIG. 3 is a close-up of an idealized sample curved surface as seen through the aperture with all the directional light sources turned on. The orientation of the viewing angle is orthogonal to the center of the curved surface. In the figure, the bright reflections from the lights are rendered in inverse coloring as solid dark circles.

FIG. 4 is a close-up of an idealized sample curved surface as seen through the aperture with four directional light sources from each of the two groups turned on forming a diamond pattern. The orientation of the viewing angle is orthogonal to the center of the curved surface. In the figure, the bright reflections from the lights are rendered in inverse coloring as solid dark circles.

### DETAILED DESCRIPTION OF THE INVENTION

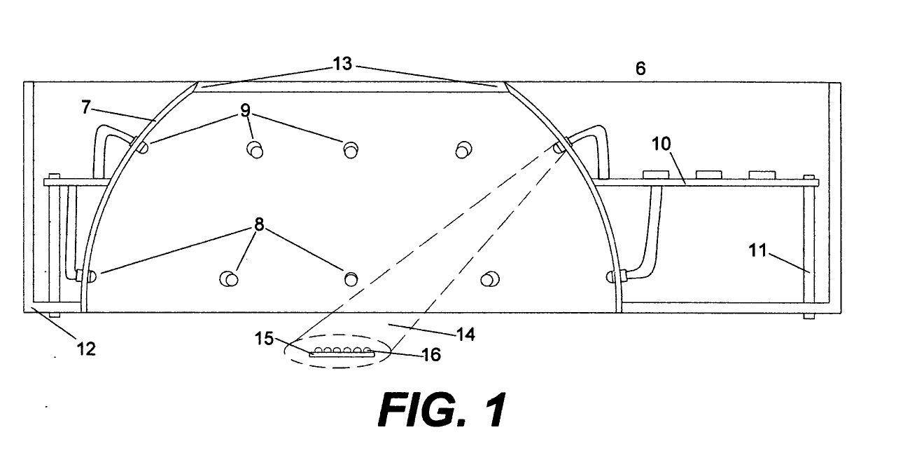

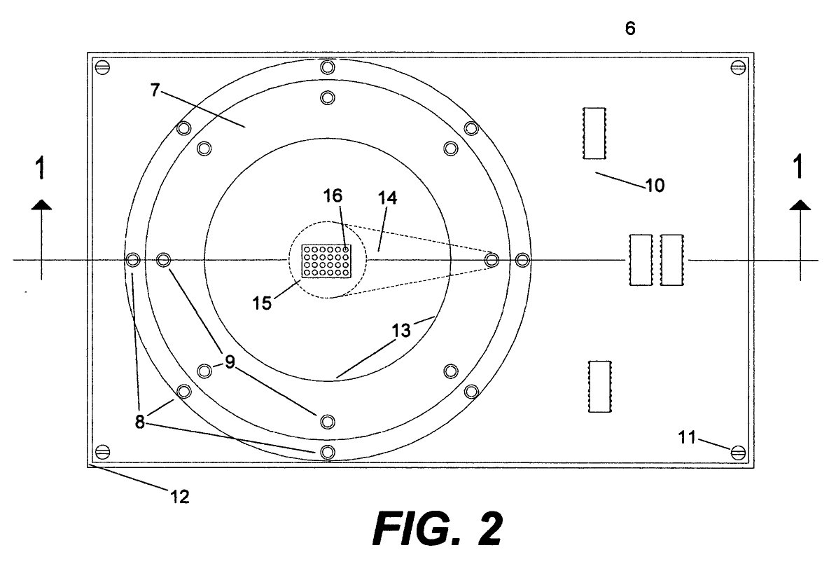

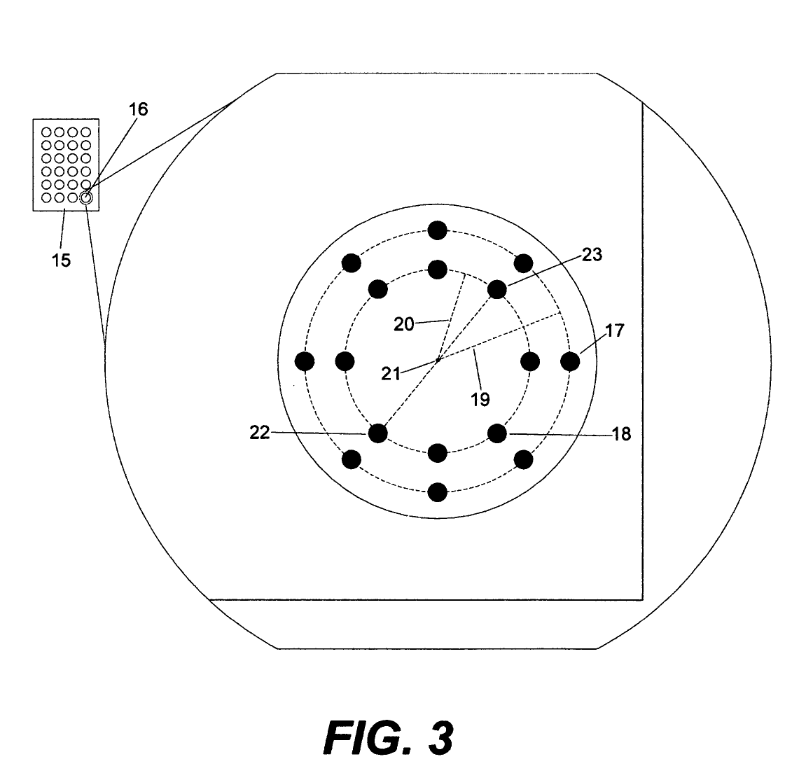

Referring now to FIGS. 1, 2, 3, and 4, an illuminator 6 is shown for providing point reflections from curved surfaces. The illuminator comprises a hemisphere 7 fabricated from plastic and painted with a flat black finish. A group of eight LEDs 8 are embedded in the hemisphere at regular 45-degree intervals circumferentially near the largest circle of the hemisphere. A second group of eight LEDs 9 are embedded at matching positions higher up in latitude on the hemisphere. The leads from the LEDs are soldered to a printed circuit board 10 which contains the control electronics and forms a support for the hemisphere. The printed circuit board is in turn mounted on standoffs 11 in a rectangular enclosure 12. The hemisphere has an aperture 13 at its peak. Beams of light from the LEDs 14 converge at the center of the largest circle of the hemisphere. A ceramic chip carrier 15 with a plurality of solder balls 16 is shown situated in the center of the hemisphere. The size of the hemisphere and the size of the ceramic chip carrier are matched so that all LEDs are approximately equidistant from the chip carrier.

In operation, the curved specular surfaces 16 to be illuminated, which are the metallic balls or bumps 16 on the surface of a chip or wafer 15 in the present embodiment, can be placed generally in the center of the hemisphere in which the two groups of LEDs 8,9 are mounted. Light from the first group 8 of eight LEDs form the larger octagonal reflection pattern 17 (“octet”) from each ball or bump. Light from the second group 9 of eight LEDs form the smaller concentric octet 18 from each ball or bump.

The patterns of LED reflections 17,18 can be used by the machine vision system to find the top center position of a ball or bump by simply finding the mid-point 21 between any two diametrically opposed surface reflections 22,23. Averaging as many symmetrical reflection pairs as are available given the quality of the reflections can increase the precision of the measurement.

The radius 19 of a circle that passes through the reflections 17 of the first group of LEDs 8 is measured with a machine vision system (not shown) looking through the aperture 13. The radius 20 of a circle that passes through the reflections 18 of the second group of LEDs 9 is also measured by the machine vision system. Once the two radii 19,20 are measured, the machine vision system can calculate the average radius of the solder ball or bump and a figure of merit as to how well the radii 19,20 correspond to each other and to manufacturing specifications.

The circular area of each individual LED reflection in the two octagonal groups 17,18 may be used as a measure of the surface quality of the ball or bump. Extremely large glaring reflections indicate a planar or concave surface rather than the normal convex spherical surface. Smaller area reflections indicate exaggerated convexity or damage to the surface producing grooves or roughness. The machine vision system measures the areas of the LED reflections and can compare the areas of diametrically opposed reflections 22,23 versus the overall average to develop a figure of merit for surface symmetry and quality.

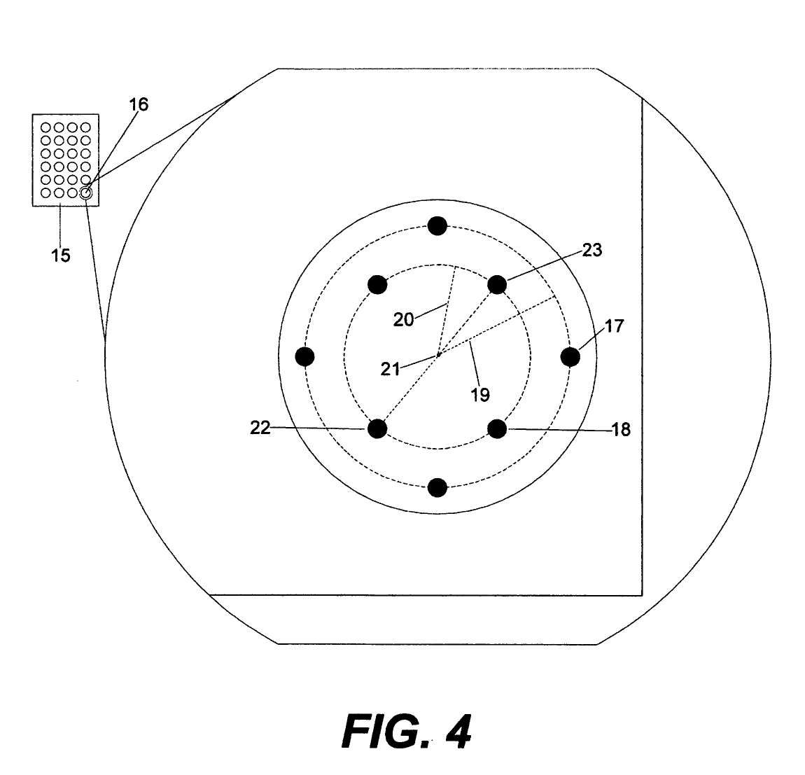

Depending on the measurement algorithms used, the machine vision system may activate each group of LEDs 8,9 sequentially, all the LEDs at once, or subsets of the two groups 8,9 together. By using subsets of groups 8,9 together, diamond and square shape patterns of reflections may be formed on the curved surfaces. FIG. 4 shows how a diamond pattern may be projected using four lights from the larger LED group 8 and four lights from the smaller LED group 9. This diamond pattern can be used to calculate two radii 19,20 with a single camera exposure. Similarly, a square pattern can be produced by using the alternate lights from each octagonal group.

When viewed with an off-axis camera, the patterns of LED reflections shift accordingly, but still provide sufficient information to locate the positions, radii, and surface quality of the balls or bumps. With this off-axis information, three-dimensional data including the relative coplanarity of each curved surface may be derived.

The foregoing describes an illuminator that projects fiducial marks onto curved specular surfaces sufficient to reflect images that can be rapidly machine processed to give position, size, height, and surface quality information.

While the invention has been particularly shown and described with reference to a preferred embodiment thereof, it will be understood by those skilled in the art that various changes in form and details may be made without departing from the spirit and scope of the invention.

1. An illuminator for use in machine vision inspection systems for providing precise points of reflection from an object having a multiplicity of curved surfaces to be inspected, said illuminator comprising:
a hemispherical structure that serves as a mechanical support for a limited number of directional light sources, said structure defining an aperture situated along an axis perpendicular to the plane passing through the largest circle of the structure, the axis passing through the center of the largest circle; and means for directing all of the beams from the light sources to converge at the center of the largest circle of the structure, so that the object having curved surfaces to be inspected, also positioned at the center of the largest circle, can reflect each of the beams of light to be inspected through the aperture.

2. An illuminator apparatus according to claim 1 that provides discrete points of high contrast reflection from curved specular surfaces by using light emitting diodes (LEDs) as the directional light sources.

3. An illuminator apparatus according to claim 1 that provides high contrast point reflections from curved specular surfaces in the shape of polygonal vertices so calculations of the sphere position and radius may be rapidly and accurately processed by a machine.

4. An illuminator apparatus according to claim 1 that provides electronically selectable polygonal reflections of multiple sizes to enhance the topological measurement precision by a machine.

5. An illuminator apparatus according to claim 1 that provides electronically selectable polygonal reflections of multiple shapes to enhance the measurement speed by a machine.

6. An illuminator apparatus according to claim 1 wherein the symmetry and size of the reflected points of the polygonal shapes provide a measure of the symmetry and quality of the sphere surface.

7. An illuminator apparatus according to claim 1 that provides an aperture large enough to accommodate inspection using a second viewing camera mounted at an off-axis of up through 30 degrees.

8. An illuminator apparatus according to claim 1 wherein the reflected points of light when viewed from an off-axis orientation can be used by a machine to determine position, size, surface quality, and relative coplanarity of each curved surface.

9. An illuminator for use in machine vision inspection systems for providing precise points of reflection from an object having a multiplicity of curved surfaces to be inspected wherein the mechanical support for the directional light sources approximates a hemispherical shape by using a limited number of planar surfaces corresponding to the number of directional light sources.

10. An illumination apparatus of claim 9 wherein mirrors are mounted on a subset of the planar surfaces to redirect the light beams and thus increase the length of travel from the directional light sources to the surface to be illuminated.
